(19) United States
(12) Patent Application Publication
(10) Pub. No.: US 2012/0296055 A1
(43) Pub. Date: Nov. 22, 2012

(54) HIGH-CIS POLYBUTADIENE RUBBER IN BENIGN SOLVENTS AND PROCESS FOR PREPARATION THEREOF

(75) Inventors: Maiti Madhuchhanda, Vadodara (IN); Jasra Rakshvir, Vadodara (IN)

(73) Assignee: RELIANCE INDUSTRIES LIMITED, Mumbai, Maharashtra (IN)

(21) Appl. No.: 13/522,154

(22) PCT Filed: Jan. 14, 2011
(86) PCT No.: PCT/IN11/00026

§ 371 Date: Jul. 13, 2012

(30) Foreign Application Priority Data
Jan. 15, 2010 (IN) 117/MUM/2010

(51) Int. Cl. C08F 136/06; C08F 4/70

(52) U.S. Cl. 526/93; 502/117

(57) ABSTRACT

Disclosed is an improved process for production of relatively gel free high cis-1,4-polybutadiene by polymerizing 1,3-butadiene monomer in presence of organocobalt-alkyl aluminum catalysts and a cycloalkane solvent system, the improvement comprising conducting said process in a predetermined sequence avoiding alkyl or alkoxy substituted benzene as polymerization regulator.

### FIELD OF THE INVENTION

This invention relates generally to processes for the production of polybutadiene rubber and more particularly to a process for production of polybutadiene rubber with high cis-1,4-content.

### BACKGROUND OF THE INVENTION

Rubber products obtained from high cis-1,4-polybutadienes [PBR] have been widely used in tire and other rubber goods by virtue of their excellent properties such as high impact resilience, low heat build-up and high wear resistance.

The polymerization of 1,3-butadiene to form high cis-1,4-polybutadiene has been a process widely known in art and has been subject of several patents and publications.

Typically, the molecular weight as well as the molecular weight distribution is directly concerned with the processability and physical propertied of polymer. There is a need for rubbers having a low molecular weight and a considerably high molecular weight distribution in the manufacture of tires with improved processability.

As described above, many applications of cis-1,4-polybutadiene require lower molecular weight polymers than those generally obtained from commonly used polymerization systems. For example, in manufacture of automobile tires, it is desirable to use a high cis-1,4-polybutadiene having a Dilute solution Viscosity (DSV) of about 3 as it provides improved treadwear characteristics for automobile and truck tires. In most cases, the cis-1,4-polybutadiene rubber is blended with one or more other rubbers to attain the desired tire tread characteristics. On the other hand, if the high cis-1,4-polybutadiene is used in a sealant or in a paint, liquid polybutadienes are usually employed.

Polymerization of conjugated dienes, especially 1,3-butadiene, is well known in the art using a variety of catalysts, including a mixture of a cobalt and an aluminum compound. U.S. Pat. No. 3,135,725 discloses cobalt salt-hydrocarbyl aluminum compound catalysts and U.S. Pat. No. 3,046,265 discloses alkyl aluminum, cobalt halide and acetyl halide catalyst, both catalyst systems being useful in polymerizing conjugated diolefins.

Many commercial processes are known to produce high cis-polybutadiene using cobalt based catalysts in a continuous way in an aromatic solvent like benzene. Despite their good properties, aromatic hydrocarbon solvents because of their toxicity, and especially benzene because of its carcinogenic effect, pose a great danger to the environment. Consequently, there has been an ongoing effort to replace the toxic aromatic solvents with less/non toxic ones.

Carcinogenic aromatic solvent is being replaced by aliphatic solvents like cyclohexane. In these solvents the polymerization control is likely to be troublesome, leading to increased gel content of the product. Therefore, polymerization regulators, such as alkyl or alkoxy substituted benzene, are being used along with such aliphatic solvents as disclosed in U.S. Pat. No. 4,224,426 and U.S. Pat. No. 5,691,429.

Although generally the order of addition of the reactants and the catalysts apparently was not considered to be of critical importance, various patents disclose different orders of addition. For example, in British Pat. No. 926,036 the reactants and catalysts were added in the order of solvent, aluminum compound, cobalt chloride in pyridine and finally butadiene while in British Pat. No. 924,427 the order was: aromatic solvent, cobalt and then aluminum compounds as catalysts, additional aromatic solvent, aliphatic solvent and finally butadiene. U.S. Pat. No. 3,284,431 discloses adding to the reaction vessel an aromatic solvent, butadiene, an aluminum compound catalyst an activator and finally a cobalt compound catalyst. Different order of addition is disclosed in U.S. Pat. No. 3,646,001 where cobalt and aluminum catalysts, such as cobalt octoate, and diethyl aluminum chloride, are prereacted in wet benzene at a temperature below 20° C. followed by addition of butadiene and additional solvents such as benzene and butene-1. Published Japanese patent application SHO-44-10276 discloses dissolving a cobalt catalyst in dry toluene, feeding 1,3-butadiene to the reaction vessel and then adding an aluminum catalyst to begin polymerization. This method, however, yields cis-1,4-polybutadiene having a relatively high gel content.

The use of water in polymerization process for butadiene increases a polymerization activity but results in formation of a large amount of a gelled polymer (hereinafter referred to as “gel”). The resulting polybutadiene containing high gel has limited usage. Water as a catalyst component can be added to a polymerization system using butadiene having water dissolved therein or an inert organic solvent. However, for water to reach a given amount, there is a need for conjointly using anhydrous butadiene or an anhydrous inert organic solvent, and the operation becomes complex. Ordinarily used is a process in which water is added to a polymerization solvent or a polymerization solvent solution of 1,3-butadiene and dispersed with stirring. This process is simple but heavily forms a gel. This adds to list of persistent problems of art demanding addressal.

Industrial scale production of polybutadiene rubber makes continuous mode of synthesis preferable than batch modes. From a commercial standpoint, batch-type polymerization processes are not as desirable as continuous polymerization processes as the latter permits much greater production rates.

Thus, there still exists a need for the discovery of a process for preparing gel-free, high cis-1,4 polybutadiene without any polymerization regulator in a benign aliphatic solvent.

To address these and other problems of art have been focus of research by the present inventors who have come up with novel solutions to the same. The description hereinunder seeks to explain and elaborate various nuances of these novel solutions.

### OBJECTS OF THE INVENTION

It is an object of the present invention to provide a process for preparing low gel, high cis-1,4 polybutadiene using a batch or continuous mode of operation.

It is still another object of the present invention to provide for a industrial process for production of polybutadiene rubber which obviates the use of environmentally dangerous and carcinogenic reactants.

Yet another object of the present invention is to allow fine control over rate of polymerization of 1,3-butadiene and molecular size of resultant polymer.

Yet another object of the present invention is to provide an industrial process for polymerization of 1,3-butadiene to obtain a polybutadiene rubber product having low gel content, said method being characterized in obviating need for ageing of catalysts used.

These and other objects of the present invention shall present themselves to the reader upon the summary and detailed description of invention contained hereinafter.

### SUMMARY OF THE INVENTION

The polymerization of 1,3-butadiene is carried out in the presence of a catalyst containing a cobalt compound and one or more aluminum compounds. The improvement of this invention comprises adding sequentially to the reaction vessel: butadiene-solvent feed, water, alkyl aluminum compound, cobalt catalyst. Addition of monomer may be performed at the end as well. Use of aromatic or pi-electron donating solvents is de-necessitated.

### DETAILED DESCRIPTION OF THE INVENTION

This invention is directed to an improved method for polymerizing 1,3-butadiene to produce a polybutadiene rubber product with cis-1,4-polybutadiene as dominant species (≧96%) and characterized in having a substantially reduced gel content. Control of molecular weight of resultant polymer is achieved by a specific sequence of addition of monomer, catalyst, co-catalyst, promoter, by use of an aliphatic solvent. Process of the present invention is distinguished from common art by obviating necessity of ageing the catalysts used. Additionally, use of expensive diluents/co-solvents such as 1-butene is avoided.

According to principles of the present invention, preferred order of addition of the various components comprises charging the feed (butadiene monomer dissolved in solvent) first, followed by promoter (water), then co-catalyst (alkyl aluminums) and the catalyst (Cobalt compound), respectively in sequence or the solvent, then the promoter (water), the co-catalyst (alkyl aluminums) and the catalyst (Cobalt compound) and finally the monomer in sequence. Initial addition of water gives better dispersion of water in the feed, then co-catalyst is added, which generates an aluminoxane structure with required Lewis acidity. When catalyst is added, then only it forms a catalytically active centre and the initiation of reaction can be observed. If the monomer is added at the end of the sequence, then the reaction is extremely controlled and the gel-content is minimized. Other additives, such as chain transfer agent (CTA) for a further degree of control of molecular weight, are added as usual after the catalysts. While in a conventional process for high-cis PBR manufacture, reduction of catalyst activity is achieved through use of aromatic solvent, particularly benzene, which donates pi-electron to the catalyst centre, present invention achieves desired molecular weight and gel control by using even a purely aliphatic solvent like cyclohexane that is completely inert and neutral to either the catalyst system or the monomer and only acts as physical diluent for both monomer and polymer. This has been achievable because the sequential addition of monomer and catalyst system and the catalyst doses has performed the molecular weight and gel control even in only cyclohexane solvent.

It is reported in the prior arts that the control of reaction in 100% cyclohexane is very tough to control and leads to high gel content. Polymer is highly soluble in cyclohexane, it does not precipitate. While the conventional process has 20-40% by weight of alpha-olefin—particularly 1-butene—in the solvent composition along with the major, aromatic or cycloalkane solvents and working as an efficient heat transfer agent (to keep reaction temperature <30° C.). The heat of polymerization is absorbed by the lighter components which boil off [1-butene], flow up into the reflux condenser and return as liquid. The present invention employing cyclohexane as a solvent completely does away with the costly 1-butene.

According to one aspect of the present invention, the order of addition of the various materials to the reaction vessel is most critical and determines kinetics and throughput of the process for polymerizing 1,3-butadiene to produce a polybutadiene rubber product with cis-1,4-polybutadiene as dominant species as outlined in the description herein.

The process of this invention can be carried out in batch as well as continuous way. According to another aspect of the present invention, polymerization is typically started by adding the cobalt-based catalyst system to the polymerization medium. It is one of the unique features of the present invention that rate of polymerization in 100% cycloalkane could be controlled without using any polymerization regulator only by controlling the catalysts dose, reaction temperature, catalyst addition sequence and better water dispersion. The resulting polymer product was of substantially low gel content.

The temperatures utilized in the polymerizations of this invention are not critical and may vary from over a wider range. For instance, such polymerizations can be conducted at any temperature within the range of about −10.degree. C. to about 130.degree. C. The polymerizations of this invention will preferably be conducted at a temperature within the range of about 20.degree. C. to about 100.degree. C. It is normally preferred for the polymerization to be carried out at a temperature which is within the range of about 20.degree. C. to about 35.degree. C.

After the polymerization is completed, the cis-1,4-polybutadiene rubber may be recovered from the resulting polymer solution (rubber cement) by any of several procedures. One such procedure comprises mixing the rubber cement with a polar coagulating agent, such as methanol, ethanol, isopropanol, acetone or the like. The coagulated rubber is recovered from the slurry of the polar coagulating agent by centrifugation, decantation or filtration.

Another procedure for recovering the cis-1,4-polybutadiene rubber is by subjecting the rubber solution to spray drying. Such a procedure is particularly suitable for continuous operations and has the advantage that heat requirements are at a minimum. When such a procedure is used, the recovered polymer should be washed soon after recovery with a polar solvent in order to destroy the remaining active catalyst contained in the polymer. In such procedures, the vaporized organic solvents are also easily recovered but will normally require purification before being recycled.

According to another aspect of the present invention, formation of the gel is markedly inhibited during the polymerization process. Since the resulting polybutadiene is substantially gel-free, the usage of polybutadiene is not limited.

A process of polymerizing 1,3-butadiene to produce substantially gel free; cis-1,4-polybutadiene. The process comprises polymerization of 1,3-butadiene using a catalyst system comprising at least one cobalt compound, at least one organo aluminum and water, in 100% cycloalkane. This process is a cost effective one, as it eliminates usage of costly alpha-olefins. Rate of polymerization in 100% cycloalkane is controlled without using any polymerization regulator but by controlling the catalysts dose, reaction temperature, catalyst addition sequence and improved water dispersion.

The cost effective applicability of the present invention lies in the use of fully aliphatic solvents in manufacturing polybutadiene rubber with low gel content and avoidance of expensive butene-1 as complementary diluent in manufacturing such rubber.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever. In the following examples, all temperatures are set forth uncorrected in degree Celsius; unless otherwise indicated, all parts and percentages are by weight.

Reference is now hereby made to some exemplary embodiments which illustrate performa of the present invention. It shall be evident to the reader that these examples are in no way restrictive to the spirit and scope of the present invention.

### EXAMPLE

Table 1 illustrates various embodiments of the present invention wherein substantially gel free, cis-1,4-polybutadiene was obtained as an end product.

| | Example number | | | | |
|---|---|---|---|---|---|
| Description | 1 | 2 | 3 | 4 | 5 |
| 1,3-butadiene, | 54 | 14 | 385 | 397 | 300 |
| g | | | | | |
| Diethyl | 2.69 | 0.87 | 23.10 | 16.67 | 16.50 |
| aluminum | | | | | |
| chloride, mmol | | | | | |
| Cobalt | 0.010 | 0.002 | 0.085 | 0.064 | 0.099 |
| octanoate, | | | | | |
| mmol | | | | | |
| Cyclohexane, g | 195 | 61 | 1558 | 1326 | 1326 |
| Water, ppm | 75 | 52 | 47 | 38 | 40 |
| 1,5 COD, g | — | 0.03 | 1.08 | 1.39 | 1.32 |
| Reaction time, | 15 | 25 | 70 | 70 | 70 |
| min. | | | | | |
| Reaction | 28 | 22 | 24 | 24 | 27 |
| temperature, | | | | | |
| ° C. | | | | | |
| Conversion, % | 23 | 30 | 55 | 50 | 70 |
| Intrinsic | 2.2 | 2.5 | 2.2 | 1.5 | 1.4 |
| viscosity, | | | | | |
| cm³/g | | | | | |
| Gel, ppm | 1200 | 950 | 520 | 490 | 750 |
| ML₁₊₄@ | — | — | 70 | 28 | 22 |
| 100° C. | | | | | |
| Cis-content, % | 97.6 | 97.2 | 98.0 | 97.3 | 96.3 |

Yet other advantages of the present invention will become apparent to those skilled in the art from the foregoing description wherein there is described and shown a preferred embodiment of the present invention. As will be realized, the present invention is capable of various other embodiments and that its several components and related details are capable of various alterations, all without departing from the basic concept of the present invention. Accordingly, the descriptions will be regarded as illustrative in nature and not as restrictive in any form whatsoever. Modifications and variations of the process and methods described herein will be obvious to those skilled in the art. Such modifications and variations are intended to come within the scope of the present invention.

1) A method for preparation of high cis-1,4-polybutadiene rubber, said method comprising polymerizing cis-1,3-butadiene in presence of at least one cobalt organocatalyst, at least one alkylaluminum organocatalysts, water, at least one chain transfer agent and a non-carcinogenic solvent system wherein said improvement is characterized by a substantially low gel content in resultant polymer without mandating use of polymerization regulators or ageing of catalysts, the said improvements being achieved by sequential performance of steps comprising:
adding water to solvent or solvent-monomer feed with continuous stirring for dispersing homogenously in the solvent/feed;
adding alkylaluminum co-catalyst to said dispersed feed for generating aluminoxane structure and achieving desired Lewis acidity, said alkylaluminum co-catalyst being selected from the group consisting of organoaluminum compounds;
adding cobalt catalyst to the co-catalyst treated reaction mixture for generation of catalytic active centers and resulting in charged feed, said cobalt catalyst being selected from the group consisting of organocobalt compounds; and
adding monomer, 1,3-butadiene, to said charged solvent for achieving controlled polymerization reaction and obtaining high cis-1,4-polybutadiene.

2) A method for preparation of high cis-1,4-polybutadiene rubber according to claim 1, wherein non-carcinogenic solvents used are selected from group of cycloalkanes.

3) A method for preparation of high cis-1,4-polybutadiene rubber according to claim 1, wherein said aluminum co-catalyst is diethyl aluminum chloride.

4) A method for preparation of high cis-1,4-polybutadiene rubber according to claim 1, wherein said cobalt catalyst is cobalt octanoate.

5) A method for preparation of high cis-1,4-polybutadiene rubber according to claim 1, wherein the ratio of cobalt to aluminum is in the range 1:100 to 1:500.

6) A method for preparation of high cis-1,4-polybutadiene rubber according to claim 1, wherein said chain transfer agent is selected optionally from non-conjugated dienes and cyclodiene in a concentration range between 0.1 to 2 wt % of said monomer base.

7) A method for preparation of high cis-1,4-polybutadiene rubber according to claim 1, wherein reaction temperature is in the range between 20° C. to 28° C.

8) A method for preparation of high cis-1,4-polybutadiene rubber according to claim 1, wherein charging temperature for said cobalt catalyst and said alkylaluminum catalyst is in range between 20° C. to 28° C.

9) A method for preparation of high cis-1,4-polybutadiene rubber according to claim 1, wherein concentration of monomer is in range of 10 to 30 wt % of the dry feed.

10) A method for preparation of high cis-1,4-polybutadiene rubber according to claim 1, wherein concentration of catalyst is 0.008 millimole to 0.10 millimole per hundred gram of the monomer.

11) The catalyst composition for preparation of cis-1,4-polybutadiene rubber with low gel content, said composition comprising at least one organocobalt component and at least one organoaluminum component and water, wherein ratio of water to alkylaluminum is in the range of 0.15 to 0.45.
